(19) United States
(12) Patent Application Publication
(10) Pub. No.: US 2013/0129195 A1
(43) Pub. Date: May 23, 2013

(54) IMAGE PROCESSING METHOD AND APPARATUS USING THE SAME

(71) Applicants: Chia-Hang Ho, Taipei City (TW); Chun-Te Wu, Taoyuan City (TW); Feng-Hsiang Lo, Jhubei City (TW)

(72) Inventors: Chia-Hang Ho, Taipei City (TW); Chun-Te Wu, Taoyuan City (TW); Feng-Hsiang Lo, Jhubei City (TW)

(73) Assignee: INDUSTRIAL TECHNOLOGY RESEARCH INSTITUTE, HSINCHU (TW)

(21) Appl. No.: 13/560,313

(22) Filed: Jul. 27, 2012

Related U.S. Application Data
(60) Provisional application No. 61/560,828, filed on Nov. 17, 2011.

(30) Foreign Application Priority Data
Feb. 6, 2012 (TW) 101103822

(51) Int. Cl. G06K 9/36

(52) U.S. Cl. 382/154

(57) ABSTRACT

A image processing method for obtaining a saliency map of a input image, includes the steps of: determining a depth map and an initial saliency map; selecting a (j,i)th depth on the depth map as a target depth, wherein i and j are natural numbers respectively smaller than or equal to integers m and n; selecting 2R+1 selected depths with a one-dimensional window, centered with the target depth, wherein R is a natural number greater than 1; for each of the 2R+1 selected depths, determining whether it is greater than the target depth; if so, having a corresponding (j,i)th saliency value adjusted with a difference; and adjusting parameters i and j to have each and every saliency values of the initial saliency map adjusted and accordingly obtain the saliency map.

This application claims the benefits of United States provisional application Ser. No. 61/560,828, filed on Nov. 17, 2011, and Taiwan application Ser. No. 101103822, filed Feb. 6, 2012, the subject matters of which are incorporated herein by reference.

### TECHNICAL FIELD

The disclosure relates in general to an image processing method, an image processing apparatus using the same.

### BACKGROUND

Along with technology changes with each passing days, varies kinds of image processing methods have been developed for enhancing seeing and hearing entertainment experience for consumers, such as three dimensional (3D) multimedia processing technologies, on which more attention and effort have been paid by the industries. Generally, how to have two dimensional (2D) image content converted into 3D stereo image and stereo matching technologies have been an urgent and prominent object of the industries.

### SUMMARY

According to a first aspect of the present disclosure, an image processing method and a corresponding image processing apparatus are provided, for obtaining a salience map of an input image. The image processing method includes the following steps of: obtaining a depth map of the input image, and determining an initial salience map by a processing sub-unit of the image processing apparatus, wherein the depth map and the initial salience map respectively include m×n depth values and m×n salience values, and m and n are natural numbers greater than 1; selecting an i^{th} depth value on an j^{th} row of depth values on the depth map by a selection sub-unit of the image processing apparatus, wherein j and i are respectively a natural number smaller than or equal to m, and a natural number smaller than or equal to n, i is initialized as a value of 1, and the target depth value corresponds to an (j,i) salience value on the initial salience map; obtaining an one-dimensional (1D) search window, centered at the target depth value, on the j^{th} row of depth values by a search-window sub-unit of the image processing apparatus, wherein the 1D search window encompasses selected depth values, including the (i−R)^{th} to the (i+R)^{th} depth value on the j^{th} row of depth values, and R is a natural number greater than 1; having each of the 2R+1 selected depth values within the 1D search window compared with the target depth value by a comparing sub-unit of the image processing apparatus, so as to determine whether each of the 2R+1 selected depth values is substantially greater than the target depth value; having the corresponding (j,i)^{th} salience value adjusted with an amount of variance by the comparing sub-unit, when the 2R+1 selected depth values is substantially greater than the target depth value; and adjusting j and i, and accordingly having each and every salience values on the initial salience map adjusted by the selection sub-unit, so as to obtain the salience map.

According to a second aspect of the present disclosure, an image processing apparatus for obtaining a salience map of an input image is provided. The image processing apparatus includes a processing sub-unit, a selection sub-unit, a search-window sub-unit, and a comparing sub-unit. The processing sub-unit obtains a depth map of the input image, and determining an initial salience map, wherein the depth map and the initial salience map respectively include m×n depth values and m×n salience values, and m and n are natural numbers greater than 1. The selection sub-unit selects an i^{th} depth value on an j^{th} row of depth values on the depth map, wherein j and i are respectively a natural number smaller than or equal to m, and a natural number smaller than or equal to n, i is initialized as a value of 1, and the target depth value corresponds to an (j,i) salience value on the initial salience map. The search-window sub-unit obtains an one-dimensional (1D) search window, centered at the target depth value, on the j^{th} row of depth values, wherein the 1D search window encompasses selected depth values, including the (i−R)^{th} to the (i+R)^{th} depth value on the j^{th} row of depth values, and R is a natural number greater than 1. The comparing sub-unit has each of the 2R+1 selected depth values within the 1D search window compared with the target depth value, so as to determine whether each of the 2R+1 selected depth values is substantially greater than the target depth value. When the 2R+1 selected depth values is substantially greater than the target depth value, the comparing sub-unit has the corresponding (j,i)^{th} salience value adjusted with an amount of variance. The selection sub-unit further adjusts j and i, and accordingly has each and every salience values on the initial salience map adjusted by, so as to obtain the salience map.

The above and other aspects of the disclosure will become better understood with regard to the following detailed description of the non-limiting embodiment(s). The following description is made with reference to the accompanying drawings.

### BRIEF DESCRIPTION OF THE DRAWINGS

FIG. 1 is a block diagram of an image processing apparatus according to an embodiment.

FIG. 2 is a flow chart of an image processing method according to an embodiment.

FIG. 3 is an illustration for an input image F, a depth map D, and an initial salience map Si.

FIG. 4 is a partial flow chart of the image processing method according to an embodiment.

FIG. 5 is another partial flow chart of the image processing method according to an embodiment.

FIG. 6 is a block diagram of a warping apparatus according to an embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The data processing method according to the present embodiment selectively executes iterations with different computational complexity in response to a complexity condition of a to-be-calculated target matrix.

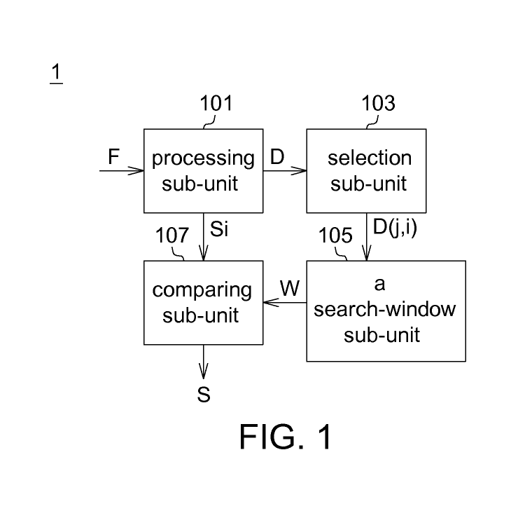

Referring to FIG. 1, a block diagram of an image processing apparatus according to an embodiment is shown. The image processing apparatus 1 employed for obtaining a salience map S corresponding to an input image F includes a processing sub-unit 101, a selection sub-unit 103, a search-window sub-unit 105, and a comparing sub-unit 107. For example, the image processing apparatus 1 can be implemented with a computer system, and the sub-units thereof can be implemented with program codes storing in a memory unit of the computer system. Thus, operations carried out by the image processing apparatus 1 can be achieved with a CPU, capable of executing the program codes or software stored in the memory unit, of the computer system.

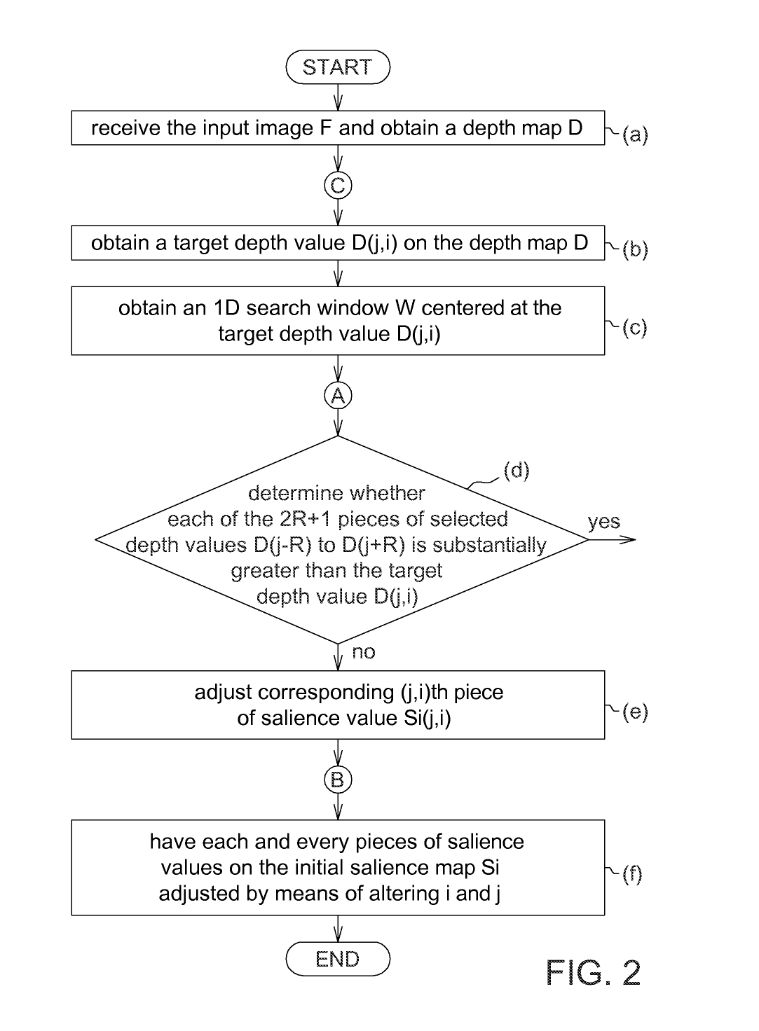

Referring to FIG. 2, a flow chart of the image processing method according to an embodiment is shown. For example, operations carried out by each of the sub-units of the image processing apparatus 1 are illustrated in FIG. 2, and the image processing method will be illustrated, more specifically, in the following paragraphs.

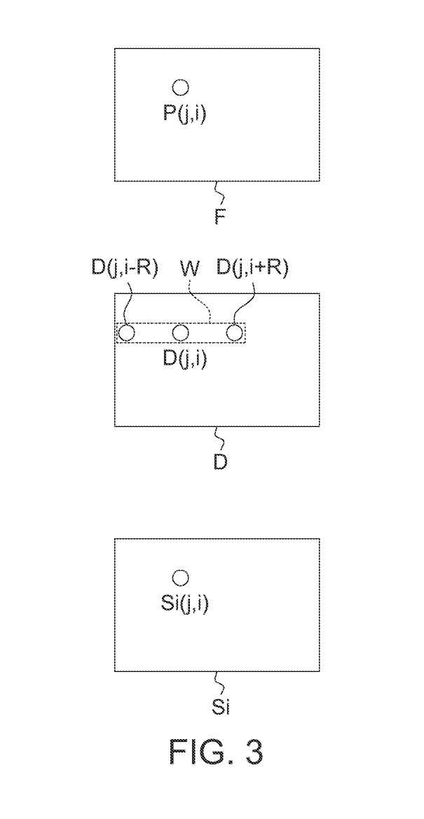

The image processing method firstly executes step (a), in which the processing sub-unit 101 receives the input image F, obtains a depth map D corresponding to the input image F, and determines an initial salience map Si thereof. For example, the depth map D includes m×n depth values D(1,1), D(1,2), . . . , D(1,n), D(2,1), D(2,2), . . . , D(2,n), . . . , and D(m,n), respectively corresponding to the m×n pixel data P(1,1) to P(m,n) of the input image F, wherein m and n are natural numbers greater than 1. The initial salience map Si includes m×n salience values Si(1,1), Si(1,2), . . . , Si(1,n), Si(2,1), Si(2,2), . . . , Si(2,n), . . . , and Si(m,n), respectively corresponding to the m×n depth values D(1,1) to D(m,n). For example, FIG. 3 provides the illustrations of the input image F, the depth map D, and the initial salience map Si.

More specifically, each of the depth values D(1,1) to D(m,n) on the depth map D has a value range of 0 to 255, wherein when each of the depth values D(1,1) to D(m,n) gets higher, the corresponding pixel data P(1,1) to P(m,n) accordingly has a greater depth. In an exemplary example, each of the salience values Si(1,1) to Si(m,n) on the initial salience map Si corresponds to the maximum value of 255.

The image processing method next proceeds to step (b), in which the selection sub-unit 103 obtains a target depth value D(j,i) on a j^{th} row of depth values on the depth map D, wherein j and i are respectively a natural number smaller than or equal to m and a natural number greater than or equal to n. In other words, the depth value D(j,i) corresponding to the coordinate position (j,i) of the depth map D and the salience value Si(j,i), is selected as the target depth value, wherein the salience value Si(j,i) corresponds to the coordinate position (j,i) of the salience map Si.

The image processing method then proceeds to step (c), in which the search-window sub-unit 105 obtains an one-dimensional (1D) search window W centered at the target depth value D(j,i). For example, the 1D search window W encompasses 2R+1 selected depth values, including the (i−R)^{th} to the (i+R)^{th} depth value D(j,i−R) to D(j,i+R) on the j^{th} row of depth values on the depth map D, wherein R is a natural number greater than 1.

The image processing method next proceeds to step (d), in which the comparing sub-unit 107 has each of the 2R+1 selected depth values, e.g. the depth values D(j,i−R), D(j,i−R+1), D(j,i−R+2), . . . , D(j,i), D(j,i+1), . . . , and D(j,i+R), compared with the target depth value D(j,i), so as to determine whether each of the 2R+1 selected depth values D(j−R) to D(j+R) is substantially greater than the target depth value D(j,i). When any of the 2R+1 selected depth values D(j−R) to D(j+R) is substantially greater than the target depth value D(j,i), the image processing method proceeds to step (e), in which the comparing sub-unit 107 has the corresponding (j,i)^{th} salience value Si(j,i) adjusted with an amount of variance.

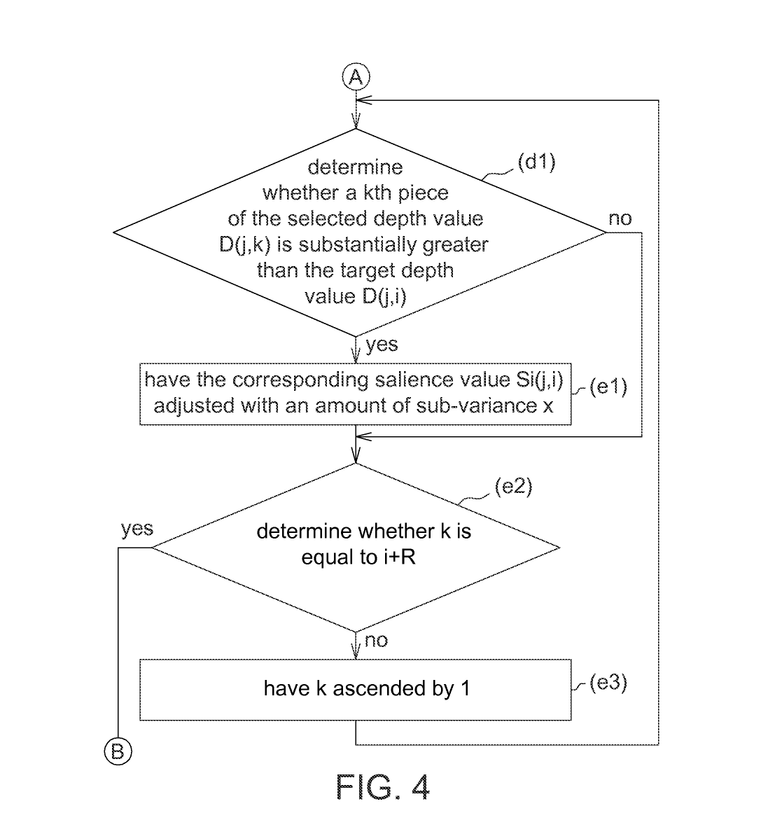

Referring to FIG. 4, a partial flow chart of the image processing method according to an embodiment is shown. For example, steps (d) and (e) of the image processing method according to the present embodiment further includes sub-steps (d1), (e1), (e2), and (e3). When sub-step (d1)) is executed, the comparing sub-unit 107 determines whether a k^{th} selected depth value D(j,k), among the 1D search window W, is substantially greater than the target depth value D(j,i), wherein k has a value range of i−R to i+R, and k is initially set to the value of i−R. In other words, the comparing sub-unit 107 determines whether the k^{th} selected depth value, e.g. the depth value D(j,i−R), is substantially greater than the target depth value D(j,i).

When the k^{th} selected depth value is substantially greater than the target depth value D(j,i), the image processing method proceeds to step (e1), in which the comparing sub-unit 107 has the corresponding salience value Si(j,i) adjusted with an amount of sub-variance x. In an exemplary example, the sub-variance x is fixed-valued, such as equal to a value of 2. In other words, when the k^{th} selected depth value is substantially greater than the target depth value D(j,i), the comparing sub-unit 107 has the salience value Si(j,i), corresponding to the target depth value D(j,i), descended by the value of 2. In still another exemplary example, the sub-variance x is relevant to the difference between the k^{th} selected depth value and the target depth value D(j,i). In other words, the salience value Si(j,i), corresponding to the target depth D(j,i), is more prominently lowered when the k^{th} depth value exceed the target depth value D(j,i) by a greater margin.

On the other hand, the comparing sub-unit 107 accordingly skips the adjustment of the salience value Si(j,i), executed in step (e1), when the k^{th} selected depth value is substantially smaller than the target depth value D(j,i).

The image processing method next proceeds to step (e2), in which the comparing sub-unit 107 further determines whether k is equal to i+R. If not, the image processing method proceeds to step (e3), in which the comparing sub-unit 107 has k ascended by 1, and the image processing method accordingly re-enters step (d1). Thus, the image processing method according to the present embodiment is capable of determining the correlation between each of the 2R+1 selected depth values D(j,i−R) to D(j,i+R) and the target depth value D(j,i) and accordingly having the salience value Si(j,i) adjusted by means of executing steps (d1), (e1), and (e2).

After that, the image processing method proceeds to step (f), in which the selection sub-unit 103 has each and every salience values on the initial salience map Si adjusted by means of altering i and j. So as to obtain an adjusted salience map S according to the initial salience map Si.

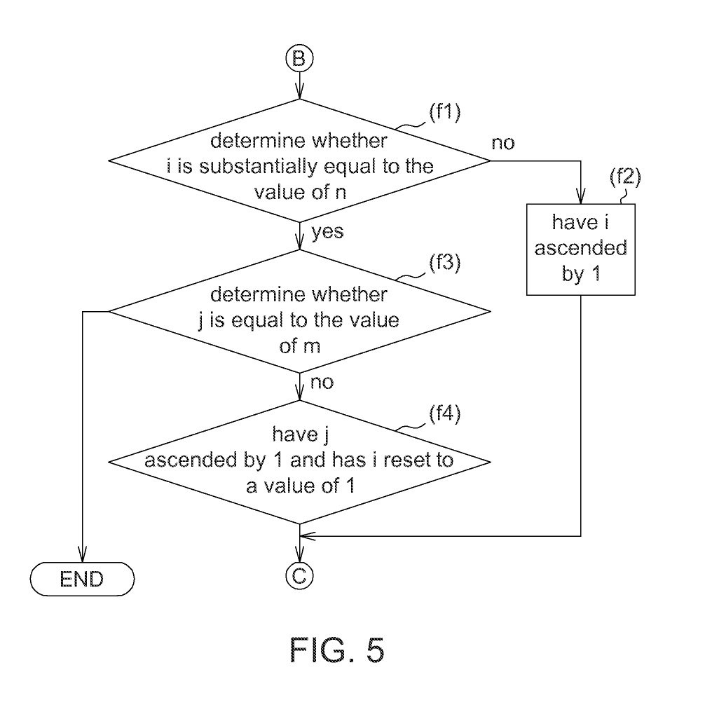

Referring to FIG. 5, a partial flow chart of the image processing method according to an embodiment is shown. For example, step (f) of the image processing method according to the present embodiment further includes sub-steps (f1)) to (f4). Firstly, step (f1) is executed, wherein the selection sub-unit 103 determines whether i is substantially equal to the value of n. If not, step (f2) is executed, wherein selection sub-unit 103 has i ascended by 1. Afterward, the image processing method proceeds back to step (b), so as to select a next target depth value on the j^{th} row of depth values on the depth map D and accordingly achieve the corresponding operations.

On the other hand, when i is equal to the value of n, step (f3) is executed, wherein the selection sub-unit 103 determines whether j is equal to the value of m. If not, step (f4) is executed, wherein the selection sub-unit 103 has j ascended by 1 and has i reset to a value of 1. Afterward, the image processing method further proceeds back to step (b), so as to achieve the corresponding operations. In contrary, when j is equal to the value of m, it is indicated that adjust operations of each and every salience value Si(j,i), respectively corresponding to each and target depth value D(j,i), has been achieved by the image processing method. In other words, the salience map S, obtained according to the initial salience map Si, has been obtained, and the image processing method accordingly proceeds to an end.

The image processing method and the image processing apparatus 1 according to the present embodiment obtain the depth map D, and accordingly obtain the initial salience map Si. The image processing method and the corresponding image processing apparatus 1 further obtain a 1D search window W, which is centered at the target depth value D(j,i) and accordingly encompasses 2R+1 selected depth values D(j,i−R) to D(j,i+R), on the depth map D. The image processing method and the corresponding image processing apparatus 1 further obtain the correlations between each and every selected depth values D(j,i−R) to D(j,i+R) and the target depth value D(j,i) by means of comparing, and accordingly have the target depth value D(j,i) adjusted. In other words, the image processing method and the corresponding image processing apparatus 1 obtain each of salience values S(1,1) to S(m,n) with reference to the relative foreground-background correlation among each corresponding one of pixel data P(1,1) to P(m,n) and its neighboring pixel data.

Based on the above mentioned operation, the image processing method and the corresponding image processing apparatus 1 is able to have those pixel data, indicated as foreground compared to their neighboring pixel data, within the input image F corresponding to lower salience values, and accordingly have those pixel data, indicated as background compared to their neighboring pixel data, within the input image F corresponding to higher salience values. Generally, human brains incline to neglect background portions of an image in human brain visual process. Thus, image portions corresponding to higher human visual attention and that corresponding to lower human visual attention within the input image F can be more efficiently distinguished by system designers by means of referring to the salience map S obtained by the image processing method according to the present embodiment. The system designers may employs the salience map S as a mask for achieving different image processes on the portions corresponding to higher human visual attention and that corresponding to lower human visual attention, so as to achieve image processes with enhanced flexibility.

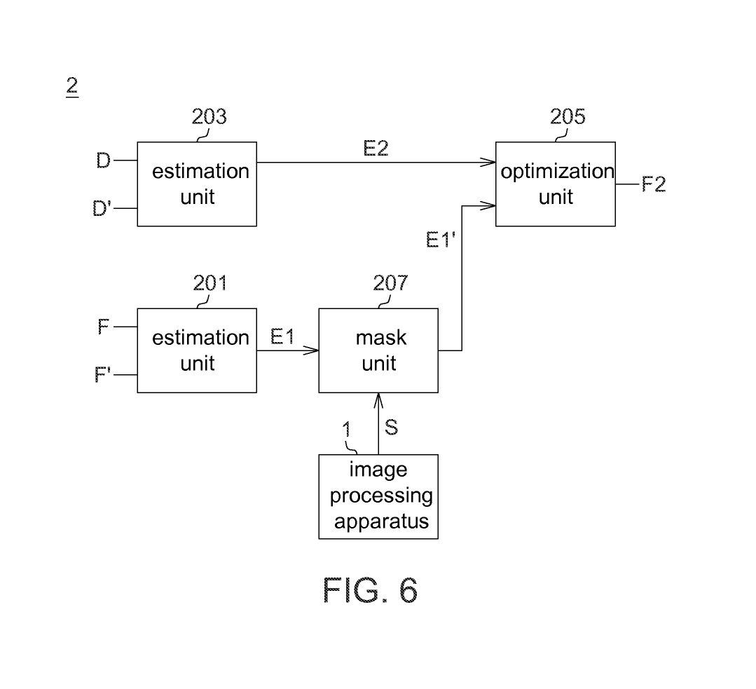

In an exemplary example, the salience map S according to the present embodiment can be employed in a warp apparatus for three dimensional (3D) image generation 2, as depicted in FIG. 6. For example, the warp apparatus 2 includes estimation units 201, 203, and an optimization unit 205. The estimation unit 201 obtains energy E1 according to a two dimensional (2D) image constraint C1, the input image F, and a warped second-view-angle image F′. The estimation unit 203 obtains a warped depth map D′ according to the warped second-view-angle image F′, and obtains energy E2 according to a depth constraint C2, the depth map D, and the warped depth map D′.

The 2D image constraint C1 includes an image distortion constraint C1_1 and an edge bending constraint C1_2. More specifically, the image distortion constraint C1_1, for example, satisfies the following equation (1):

$$\frac{\partial {ω}_{x}}{\partial x} = 1 \qquad ( 1 )$$

Wherein the parameter ωₓ is the variances on x coordinate values for each and every pixel data within the warped second-view-angle image F′; the parameter x is the x coordinate values for each and every pixel data within the input image F.

The edge bending constraint C1_2, for example, satisfies the following equation (2):

$$\frac{\partial {ω}_{x}}{\partial y} = 0 \qquad ( 2 )$$

Wherein the parameter ωₓ is the variances on x coordinate values for each and every pixel data within the warped second-view-angle image F′; the parameter y is the y coordinate values for each and every pixel data within the input image F.

The depth constraint C2, for example, satisfies the following equation (3):

ωₓ−x−dᵢ=0 (3)

Wherein the parameter ωₓ is the variances on x coordinate values for each and every pixel data within the warped second-view-angle image F′; the parameter x is the x coordinate values for each and every pixel data within the input image F; the parameter dᵢ is the depth value, corresponding each and every pixel data, on the depth map D.

The optimization unit 205 receives the energies E1 and E2 and achieves an optimization search operation on the energies E1 and E2, to accordingly obtain an optimized second-view-angle image F2. For example, the optimization unit 205 selectively employs one of the Gauss-Seidel Iteration algorithm and the multi-grid algorithm, for achieving energy minimization operation, and accordingly realizing the operation of obtaining the optimized second-view-angle image F2.

The warp apparatus 2, illustrated in FIG. 6, achieves the calculation operation of the salience map S by means of employing the image processing apparatus 1 according to the present embodiment of the disclosure. The warp apparatus 2 shown in FIG. 6 includes a mask unit 207, which employs the salience map S as a mask for altering the energy E1, and accordingly obtains an adjusted energy E1′. For example, the mask unit 207 has the energy, included in the salience map S and corresponding to those image parts with higher salience values, multiplied by a first salience parameter, and has the energy included in the salience map and corresponding to hose image parts with lower salience values, multiplied by a second salience parameter, wherein the first salience parameter is, for example, greater than the second salience parameter. Thus, as the energy minimization operation is executed, the warp apparatus 2 is capable of suppressing the amount of distortion occurs in those image parts with higher salience values, so as to assure that the corresponding image portions, corresponding to higher salience values, of the obtained warp second-view-angle image F2 are rendered with minor distortions. Consequently, the warp apparatus 2 is advantageously capable of rendering the warp second-view-angle image F2 with lowered distortion and higher image quality.

The image processing method and the corresponding image processing apparatus obtain a depth map corresponding to an input image and an initial salience map. The image processing method and the image processing apparatus further obtain a 1D search window, which is centered at a target depth value and accordingly encompasses multiple selected depth values, on the depth map. The image processing method and the corresponding image processing apparatus further obtain the correlations between each and every selected depth values and the target depth value by means of comparing, and accordingly have the target depth value adjusted. Thus, in comparison to conventional image processing method, the image processing method according to the present embodiment is advantageously capable of obtaining each salience values with reference to the relative foreground-background correlation among each corresponding one of pixel data and its neighboring pixel data.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A image processing method, applied in an image processing apparatus, for obtaining a salience map of an input image, comprising:
obtaining a depth map of the input image, and determining an initial salience map by a processing sub-unit of the image processing apparatus, wherein the depth map and the initial salience map respectively include m×n depth values and m×n salience values, and m and n are natural numbers greater than 1;
selecting an i^{th} depth value on an j^{th} row of depth values on the depth map by a selection sub-unit of the image processing apparatus as an target depth value, wherein j and i are respectively a natural number smaller than or equal to m, and a natural number smaller than or equal to n, i is initialized as a value of 1, and the target depth value corresponds to an (j,i) salience value on the initial salience map;
obtaining an one-dimensional (1D) search window, centered at the target depth value, on the j^{th} row of depth values by a search-window sub-unit of the image processing apparatus, wherein the 1D search window encompasses selected depth values, including the (i−R)^{th} to the (i+R)^{th} depth value on the j^{th} row of depth values, and R is a natural number greater than 1;
having each of the 2R+1 selected depth values within the 1D search window compared with the target depth value by a comparing sub-unit of the image processing apparatus, so as to determine whether each of the 2R+1 selected depth values is substantially greater than the target depth value;
having the corresponding (j,i)^{th} salience value adjusted with an amount of variance by the comparing sub-unit, when the 2R+1 selected depth values is substantially greater than the target depth value; and
adjusting j and i, and accordingly having each and every salience values on the initial salience map adjusted by the selection sub-unit, so as to obtain the salience map.

2. The image processing method according to claim 1, wherein the step of adjusting j and i further comprises:
determining whether i is equal to n by the selection sub-unit;
having i ascended by 1 and repeating the step of selecting the i^{th} depth value on an j^{th} row of depth values on the depth map by the selection sub-unit, when i is not equal to n;
determining whether j is equal to m, when i is equal to n by the selection sub-unit; and
having j ascended by 1, i reset, and entering the step of selecting the i^{th} depth value on a j^{th} row of depth values on the depth map by the selection sub-unit, when j is not equal to m.

3. The image processing method according to claim 1, wherein the steps of determining whether each of the 2R+1 selected depth values is substantially greater than the target depth value and the step of having the corresponding (j,i)^{th} salience value adjusted further respectively comprise:
determining whether a k^{th} selected depth value, among the 1D search window W, is substantially greater than the target depth value by the comparing sub-unit, wherein k has a value range of i−R to i+R, and k is initially set to the value of i−R; and
having the corresponding (j,i)^{th} salience value adjusted with an amount of sub-variance by the comparing sub-unit, when the k^{th} selected depth value is substantially greater than the target depth value.

4. The image processing method according to claim 3, further comprising:
determining whether k is equal to i+R by the comparing sub-unit; and
having k ascended by 1 and proceeding back to the step of determining whether the k^{th} selected depth value, among the 1D search window W, is substantially greater than the target depth value by the comparing sub-unit.

5. The image processing method according to claim 1, after obtaining the salience map, the image processing method further obtaining a second-view-angle image corresponding to the input image, so as to achieve three dimensional (3D) image generation, the image processing method comprising:
obtaining a first energy according to a two dimensional (2D) image constraint, the input image, and a warped second-view-angle image by a first estimation unit of the image processing apparatus;
obtaining a warped depth map according to the warped second-view-angle image, and obtaining a second energy according to a depth constraint, the depth map, and the warped depth map by a second estimation unit of the image processing apparatus;
employing the salience map as a mask for altering the second energy, and accordingly obtaining adjusted second energy by a mask unit of the image processing apparatus; and
achieving an optimization search operation on the first energy and the adjusted second energy, to accordingly obtain an optimized second-view-angle image by an optimization unit of the image processing apparatus.

6. The image processing method according to claim 5, wherein the optimization search operation applied on the first energy and the adjusted second energy is selectively implemented with one of a Gauss-Seidel iteration algorithm or a multi-grid algorithm.

7. The image processing method according to claim 5, wherein the 2D image constraint includes an image distortion constraint and an edge bending constraint.

8. The image processing method according to claim 7, wherein the image distortion constraint satisfies:
$$\frac{\partial {ω}_{x}}{\partial x} = 1$$
wherein the parameter ωₓ is a variances on x coordinate values for each and every pixel data within the second-view-angle image; the parameter x is an x coordinate values for each and every pixel data within the input image.

9. The image processing method according to claim 7, wherein the edge bending constraint satisfies:
$$\frac{\partial {ω}_{x}}{\partial y} = 0$$
wherein the parameter ωₓ is a variances on x coordinate values for each and every pixel data within the second-view-angle image; the parameter y is a y coordinate values for each and every pixel data within the input image.

10. The image processing method according to claim 5, wherein the depth constraint satisfies:
ωₓ−x−dᵢ=0
wherein the parameter ωₓ is a variances on x coordinate values for each and every pixel data within the second-view-angle image; the parameter x is an x coordinate values for each and every pixel data within the input image F; the parameter dᵢ is a depth value, corresponding each and every pixel data, on the depth map.

11. An image processing apparatus for obtaining a salience map of an input image, comprising:
a processing sub-unit, obtaining a depth map of the input image, and determining an initial salience map, wherein the depth map and the initial salience map respectively include m×n depth values and m×n salience values, and m and n are natural numbers greater than 1;
a selection sub-unit, selecting an i^{th} depth value on an j^{th} row of depth values on the depth map as an target depth value, wherein j and i are respectively a natural number smaller than or equal to m, and a natural number smaller than or equal to n, i is initialized as a value of 1, and the target depth value corresponds to an (j,i) salience value on the initial salience map;
a search-window sub-unit, obtaining an one-dimensional (1D) search window, centered at the target depth value, on the j^{th} row of depth values, wherein the 1D search window encompasses selected depth values, including the (i−R)^{th} to the (i+R)^{th} depth value on the j^{th} row of depth values, and R is a natural number greater than 1; and
a comparing sub-unit, having each of the 2R+1 selected depth values within the 1D search window compared with the target depth value, so as to determine whether each of the 2R+1 selected depth values is substantially greater than the target depth value, wherein
when the 2R+1 selected depth values is substantially greater than the target depth value, the comparing sub-unit has the corresponding (j,i)^{th} salience value adjusted with an amount of variance; and
the selection sub-unit further adjusts j and i, and accordingly has each and every salience values on the initial salience map adjusted by, so as to obtain the salience map.

12. The image processing apparatus according to claim 11, wherein the selection sub-unit further determines whether i is equal to n; if not, the selection sub-unit has i ascended by 1 and accordingly selects a next target depth value on the j^{th} row of depth values on the depth map, so that the search-window sub-unit and the comparing sub-unit are able to achieve the corresponding operations on the next target depth value on the j^{th} row of depth values;
when i is equal to n, the selection sub-unit determines whether j is equal to m; if not, the selection sub-unit has j ascended by 1, has i reset, and accordingly select a next target depth value on a next j^{th} row of depth values on the depth map, so that the search-window sub-unit and the comparing sub-unit are able to achieve the corresponding operations on the next target depth value on the next j^{th} row of depth values.

13. The image processing apparatus according to claim 11, wherein the comparing sub-unit further determines whether a k^{th} selected depth value, among the 1D search window W, is substantially greater than the target depth value, k having a value range of i−R to i+R, and k initially set to the value of i−R, wherein
when the k^{th} selected depth value is substantially greater than the target depth value, the comparing sub-unit has the corresponding (j,i)^{th} salience value adjusted with an amount of sub-variance.

14. The image processing apparatus according to claim 13, wherein the comparing sub-unit further determines whether k is equal to i+R b; if not, the comparing sub-unit has k ascended by 1, so as to determine whether a next the k^{th} selected depth value is substantially greater than the target depth value.

15. The image processing apparatus according to claim 11, further for obtaining a second-view-angle image corresponding to the input image, so as to achieve three dimensional (3D) image generation, the image processing apparatus further comprising:
a first estimation unit, obtaining a first energy according to a two dimensional (2D) image constraint, the input image, and a warped second-view-angle image;
a second estimation unit, obtaining a warped depth map according to the warped second-view-angle image, and obtaining a second energy according to a depth constraint, the depth map, and the warped depth map;
a mask unit, employing the salience map as a mask for altering the second energy, and accordingly obtaining adjusted second energy; and
an optimization unit, achieving an optimization search operation on the first energy and the adjusted second energy, to accordingly obtain an optimized second-view-angle image.

16. The image processing apparatus according to claim 15, wherein the optimization search operation, executed by the optimization unit, applied on the first energy and the adjusted second energy is selectively implemented with one of a Gauss-Seidel iteration algorithm or a multi-grid algorithm.

17. The image processing apparatus according to claim 15, wherein the 2D image constraint includes an image distortion constraint and an edge bending constraint.

18. The image processing apparatus according to claim 17, wherein the image distortion constraint satisfies:
$$\frac{\partial {ω}_{x}}{\partial x} = 1$$
wherein the parameter ωₓ is a variances on x coordinate values for each and every pixel data within the second-view-angle image; the parameter x is an x coordinate values for each and every pixel data within the input image.

19. The image processing apparatus according to claim 17, wherein the edge bending constraint satisfies:
$$\frac{\partial {ω}_{x}}{\partial y} = 0$$
wherein the parameter ωₓ is a variances on x coordinate values for each and every pixel data within the second-view-angle image; the parameter y is a y coordinate values for each and every pixel data within the input image.

20. The image processing apparatus according to claim 15, wherein the depth constraint satisfies:
ωₓ−x−dᵢ=
wherein the parameter ωₓ is a variances on x coordinate values for each and every pixel data within the second-view-angle image; the parameter x is an x coordinate values for each and every pixel data within the input image F; the parameter dᵢ is a depth value, corresponding each and every pixel data, on the depth map.
